(19) United States
(12) Patent Application Publication
(10) Pub. No.: US 2024/0022993 A1
(43) Pub. Date: Jan. 18, 2024

(54) SYSTEMS AND METHODS FOR USER EQUIPMENT COOPERATION

(71) Applicants: HUA XU, Kanata (CA); JIANGLEI MA, Kanata (CA); LIQING ZHANG, Kanata (CA)

(72) Inventors: HUA XU, Kanata (CA); JIANGLEI MA, Kanata (CA); LIQING ZHANG, Kanata (CA)

(73) Assignee: HUAWEI TECHNOLOGIES CO., LTD., SHENZHEN (CN)

(21) Appl. No.: 18/475,327

(22) Filed: Sep. 27, 2023

Related U.S. Application Data
(63) Continuation of application No. 16/823,401, filed on Mar. 19, 2020.
(60) Provisional application No. 62/826,082, filed on Mar. 29, 2019.

(51) Int. Cl. H04W 40/22; H04L 45/74

(52) U.S. Cl. CPC H04W 40/22; H04L 45/74

(57) ABSTRACT

User equipment (UE) cooperation could improve latency, reliability, throughput, coverage and capacity in wireless communication systems. UE cooperation could include a group of UEs helping each other with transmissions through packet forwarding. Methods are provided that include receiving, by a UE in a predefined UE group, a plurality of packets. The plurality of packets includes a first packet that is scrambled using a UE specific identifier, and a second packet that is scrambled using a UE group specific identifier. The methods further include forwarding, by the UE, the plurality of packets.

### RELATED APPLICATIONS

This application is a continuation of U.S. patent application Ser. No. 16/823,401, entitled “SYSTEMS AND METHODS FOR USER EQUIPMENT COOPERATION”, which was filed on Mar. 19, 2020, and which claims priority to U.S. Provisional Patent Application Ser. No. 62/826,082, entitled “SYSTEMS AND METHODS FOR USER EQUIPMENT COOPERATION”, which was filed on Mar. 29, 2019, the contents of both are hereby incorporated herein by reference.

### TECHNICAL FIELD

The present disclosure relates generally to wireless communications, and in particular embodiments, to user equipment (UE) cooperation.

### BACKGROUND

In some wireless communication systems, user equipments (UEs) wirelessly communicate with a base station to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or a device-to-device (D2D) communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

UE cooperation has been proposed to improve latency, reliability, throughput, coverage and capacity in wireless communication systems. For example, UE cooperation could be used to provide diversity in space, time and frequency, and increase robustness against fading and interference. In UE cooperation, SL communications could be used for data forwarding, where some of the UEs, referred to as cooperating UEs (CUEs), act as relays for other UEs, referred to as target UEs (TUEs), to improve system throughput and coverage.

### SUMMARY

Despite the potential advantages, UE cooperation also presents some possible challenges. For example, data forwarding in UE cooperation might need to balance several factors including data privacy requirements, noise management and network resource limitations. The relative importance of each of these factors might vary for different data forwarding situations. As such, a need exists for methods of UE cooperation that are flexible to meet various data forwarding needs and requirements.

According to an aspect of the present disclosure, there is provided a method for forwarding multiple packets that are scrambled with different types of identifiers. The method includes receiving, by a first user equipment (UE) in a predefined UE group, a plurality of packets. The plurality of packets includes a first packet that is scrambled using a UE specific identifier associated with a second UE in the UE group, and a second packet that is scrambled using a UE group specific identifier associated with the UE group. The method further includes forwarding, by the first UE, the plurality of packets.

In some embodiments, the UE specific identifier includes at least one of a UE specific radio network temporary identifier (RNTI) or a configured identifier, and the UE group specific identifier includes a UE group specific RNTI.

In some embodiments, a packet is the first packet or the second packet, and forwarding the plurality of packets includes: amplifying the packet and transmitting the amplified packet; decoding the packet, re-encoding the packet, and transmitting the re-encoded packet; or determining intermediate information of the packet and transmitting the intermediate information.

In some embodiments, the packet is the first packet and decoding the packet includes descrambling the packet using the UE specific identifier; or the packet is the second packet and decoding the packet includes descrambling the packet using the UE group specific identifier.

In some embodiments, transmitting the re-encoded packet includes transmitting a different redundancy version of the re-encoded packet.

In some embodiments, the method further includes determining that a destination of the at least one packet is not the first UE.

In some embodiments, the at least one packet includes a packet destination identifier, and the method further includes determining a destination of the at least one packet using the packet destination identifier.

According to another aspect of the present disclosure, there is provided a method for forwarding multiple packets based on the respective priorities of the packets. The method includes receiving, by a user equipment (UE), a plurality of packets; and forwarding, by the UE, at least one packet of the plurality of packets based on a priority of the at least one packet being higher than a priority of at least one other packet of the plurality of packets. In some embodiments, the at least one other packet is dropped.

In some embodiments, forwarding the at least one packet includes forwarding a first packet and a second packet of the plurality of packets, a priority of the first packet is higher than a priority of the second packet, and forwarding the second packet is delayed by forwarding the first packet.

In some embodiments, the priority of the at least one packet is based on any one or more of: a priority of a radio network temporary identifier (RNTI) associated with the at least one packet; whether a destination of the at least one packet is an out-of-coverage UE or an in-coverage UE; whether the at least one packet includes an ultra-reliable low-latency communication (URLLC) packet or an enhanced mobile broadband (eMBB) packet; whether the at least one packet includes a re-transmission packet; or a modulation and coding scheme (MCS) associated with higher reliability transmission for the at least one packet.

According to a further aspect of the present disclosure, there is provided an apparatus including a memory for storing instructions; and a processor coupled to the memory for executing the instructions, the processor configured to perform any method disclosed herein. In some implementations, the apparatus is a UE.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur;

FIGS. 2A and 2B are block diagrams of an example user equipment and base station, respectively;

FIG. 3 is a block diagram illustrating an example of a network serving two UEs according to an aspect of the present disclosure;

FIG. 4 is a schematic diagram of a communications between a base station and multiple UEs in a UE group according to an embodiment of the present disclosure;

FIGS. 5A, 5B, 5C and 5D are plot diagrams illustrating a packet destination identifier or a packet source identifier being transmitted in a time-frequency resource, according to embodiments of the present disclosure;

FIG. 6 is a schematic diagram showing an example of how UE cooperation occurs between a base station and multiple user equipment in a UE group according to an embodiment of the present disclosure;

FIG. 7 is a block diagram illustrating an example of scrambling a packet for transmission on the physical downlink control channel (PDCCH) to one or more UEs in a UE group;

FIG. 8 is block diagram illustrating an example of scrambling a packet, having a packet destination identifier and a packet source identifier in downlink control information (DCI), for transmission on the PDCCH to one or more UEs in a UE group;

FIG. 9 is block diagram illustrating an example of scrambling a packet for transmission on the physical downlink shared channel (PDSCH) to one or more UEs in a UE group;

FIG. 10 is a flow diagram illustrating an example method for UE cooperation on the Uu link;

FIG. 11 is a flow diagram illustrating another example method for UE cooperation on the sidelink (SL); and

FIGS. 12-14 are flow diagrams illustrating methods according to some embodiments of the present disclosure.

### DETAILED DESCRIPTION OF ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

UE cooperation relates to coordination among multiple UEs in a UE group. The UEs in a UE group could be coordinated in terms of transmission and reception over the Uu interface link and the sidelink (SL), for example. The Uu interface link is the interface that allows data transfer between the base station and a UE. The Uu interface link includes the downlink (DL) and the uplink (UL). UE cooperation could enhance a communication system by potentially improving coverage (i.e., the area that is serviced by a communication system) and capacity (i.e., throughput that can be achieved by a communication system). UE cooperation could also improve the latency and reliability of the system. However, successful UE cooperation could require proper management of the SL between UEs in order to reduce interference and improve UE cooperation benefits.

UE cooperation could be used in applications such as enhanced mobile broadband (eMBB) and ultra-reliable low-latency communication (URLLC). Another possible application of UE cooperation and/or SL communications is vehicle to everything/anything (V2X) communication, which is an increasingly important new category of communication that may become widespread in next generation wireless communication networks, such as 5G New Radio (NR) systems. V2X refers to a category of communication scenarios, including communication from a vehicle to another vehicle (V2V), vehicle to infrastructure (V2I), and vehicle to pedestrian (V2P), for example. In general, a vehicle communicating in a network is considered to be a UE.

UE cooperation could include a group of UEs helping each other with Uu link transmissions and SL transmissions. One example is packet or data forwarding. Packet forwarding could be performed by a cooperating UE (CUE), to support communication to and/or from a target UE (TUE). The CUE and the TUE typically belong to a same UE group. By way of example, a TUE could be in a location that is out-of-coverage of a serving base station. In the case that the base station has a packet to send the TUE, the base station could transmit the packet to an in-coverage CUE on the DL, which forwards the packet to the TUE on the SL. In the case that the TUE has a packet to send to the base station, the TUE could transmit the packet to the CUE on the SL, which forwards the packet to the base station on the UL. The CUE could also forward packets between UEs in the UE group on the SL.

Maintaining UE battery life during data forwarding is one possible challenge for UE cooperation. A CUE that is performing packet forwarding might experience a reduction in battery life as a result of the UE performing additional receiving and transmitting operations, for example. However, the variety of different types of user devices and applications helps make UE cooperation feasible and beneficial. For example, devices with relatively large amounts of available power, such as vehicles, can support devices with relatively limited available power, such as mobile phones. In this example, a vehicle could be a cooperating UE (CUE) that forwards packets to a mobile phone, which acts as a target UE (TUE).

Packet forwarding could be performed using any of a number of different transmission or forwarding modes. These forwarding modes could be used in UE cooperation, packet relaying, and/or device-to-device (D2D) applications.

One type of forwarding mode is referred to as amplify and forward (AF). In the AF mode, a packet is received and amplified without decoding the packet. The amplified packet is then transmitted towards the destination of the packet. A UE or other device that performs the AF method could be referred to as a repeater. In the context of UE cooperation, a CUE performing the AF method could know the destination of the packet (for example, a TUE or base station), but might not necessarily be able to decode the packet. In some embodiments, the CUE could forward the original packet to the TUE in repetitions, and the TUE could perform chase combining on the forwarded packets. The AF mode is relatively simple and consumes relatively little power. For example, a UE performing AF does not need to consume power to decode the packet. However, the AF mode will also amplify the noise in the received packet, which could result in an increase in bit error rate (BER) at the destination of the packet.

Another type of forwarding mode is referred to decode and forward (DF). In the DF mode, a packet is received, decoded, and re-encoded. The re-encoded packet is then transmitted towards the destination of the packet. In the context of UE cooperation, a CUE performing the DF method will be able to decode a packet that is destined for a TUE. The decoding and re-encoding of the packet could reduce the noise associated with the packet. However, decoding and re-encoding could also consume more energy than the AF mode, for example. Another possible issue with the DF mode is that a CUE performing the forwarding might be able to read the data contained in the decoded packet, even though the packet is not intended for the CUE. This situation could raise data privacy concerns. In some embodiments, the re-encoded packet could be a different redundancy version (RV) of the packet, and the TUE could perform incremental redundancy (IR) combining on the received packets.

Yet another type of forwarding mode is referred to as quantize and forward (QF). In the QF mode, some quantized intermediate information could be derived from a packet by the UE performing the forwarding. The intermediate information could then be transmitted towards the destination of the packet. Non-limiting examples of quantized intermediate information include soft demodulated symbols and log likelihood ratios (LLRs). In the context of UE cooperation, a CUE performing the QF mode could know the destination of the packet (for example, a TUE or base station), but might not necessarily be able to decode the packet. The CUE could transmit the intermediate information in any of a variety of formats to the TUE. For example, the intermediate information could be transmitted using different frequency bandwidths and/or repetitions. Advantages of the QF mode include reduced privacy concerns as the packet is not decoded, and reduced noise as intermediate information of the packet is transmitted rather than, for example, an amplified version of the received packet. However, transmitting intermediate information of the packet could require additional network resources (for example, time and frequency resources) when compared to forwarding the packet itself.

The AF, DF and QF modes could be supported on the SL to facilitate UE cooperation. However, there might not be any one forwarding mode that is suitable in all situations. For example, the DF might not be suitable in situations where data privacy is desired, the AF mode might not be suitable in situations where a low level of noise is desired, and the QF mode might not be suitable in situations where low network resource requirements are desired. As such, a need exists for methods that allow for the flexible configuration and use of different forwarding modes.

Some aspects of the present disclosure relate to flexible methods for packet forwarding. Different forwarding modes could be used based on different forwarding needs or requirements.

Packets could be scrambled using a network identifier (ID). This ID could be a UE specific ID that is associated with a UE, a UE group specific ID that is associated with a UE group, or a cell ID that is associated with a cell in the network. An example of a UE specific ID is a radio network temporary identifier (RNTI), which is a type of temporary identifier for a UE. The RNTI is an identifier that is assigned to a UE by the base station, regardless of whether a UE is performing UE cooperation or not. An example of a UE group specific ID is a UE group specific RNTI, which is a type of temporary identifier for a UE group. Each UE in a UE group could be associated with, and have knowledge of, the UE group specific RNTI for that UE group. In some implementations, the RNTI may be 16 bits long. However, it may be longer or shorter in other implementations.

Scrambling a packet with an ID could include scrambling the packet with a UE specific RNTI or a UE group specific RNTI. Scrambling the packet could also or instead include masking a cyclic redundancy check (CRC) in the packet with the UE specific RNTI or the UE group specific RNTI. A CUE needs to know the RNTI that was used to scramble a packet in order to decode the packet. If a packet is scrambled using a TUE specific RNTI and the CUE does not know the TUE RNTI, then the CUE might not be able to descramble and decode the packet. In such cases, the CUE might be configured to use an AF or QF mode to forward the packet. This could provide a form of privacy for the TUE, as the CUE will not be able to read the packet intended for the TUE. If a packet is scrambled using a UE group specific RNTI, or if the packet is scrambled using the TUE RNTI but the CUE knows the TUE RNTI, then the CUE might be able to descramble and decode the packet. In such cases, the CUE might be configured to use the DF mode to forward the packet. Different RNTIs and different forwarding modes could help provide flexibility to balance data privacy requirements, noise management, and network resource limitations.

Some embodiments provided herein relate to the use of different RNTIs for physical downlink control channel (PDCCH) and/or physical downlink shared channel (PDSCH) transmissions on the Uu link and SL to balance packet decodability and data privacy for UE cooperation. Some embodiments relate to procedures provided on the Uu link and SL for UE cooperation when different transmission or forwarding modes are used on the SL to avoid ambiguity. Some embodiments relate to situations where a UE has a multiple packets waiting to be forwarded on the same time-frequency resource on the SL, and the UE needs to determine which packet could and/or should be forwarded first.

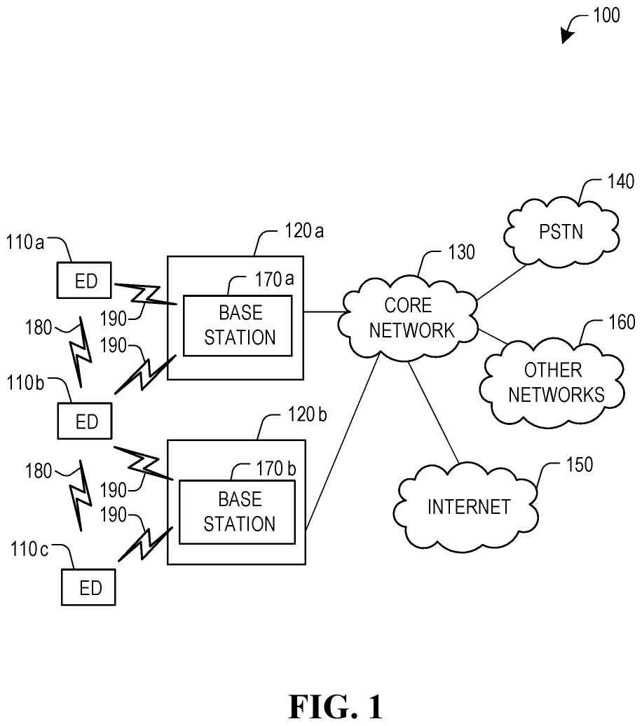

FIGS. 1, 2A, 2B and 3 illustrate examples of networks and devices that could implement any or all aspects of the present disclosure.

FIG. 1 illustrates an example communication system 100. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 1, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

In FIG. 1, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router. Any ED 110a-110c may be alternatively or additionally configured to interface, access, or communicate with any other base station 170a-170b, the internet 150, the core network 130, the PSTN 140, the other networks 160, or any combination of the preceding. The communication system 100 may include RANs, such as RAN 120b, wherein the corresponding base station 170b accesses the core network 130 via the internet 150, as shown.

The EDs 110a-110c and base stations 170a-170b are examples of communication equipment that can be configured to implement some or all of the functionality and/or embodiments described herein. In the embodiment shown in FIG. 1, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b communicate with one or more of the EDs 110a-110c over one or more air interfaces 190 using wireless communication links e.g. radio frequency (RF), microwave, infrared (IR), etc. The air interfaces 190 may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as High Speed Packet Access (HSPA), Evolved HPSA (HSPA+) optionally including High Speed Downlink Packet Access (HSDPA), High Speed Packet Uplink Access (HSUPA) or both. Alternatively, a base station 170a-170b may establish an air interface 190 with Evolved UTMS Terrestrial Radio Access (E-UTRA) using LTE, LTE-A, and/or LTE-B. It is contemplated that the communication system 100 may use multiple channel access functionality, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110c communicate with one another over one or more SL air interfaces 180 using wireless communication links e.g. radio frequency (RF), microwave, infrared (IR), etc. The SL air interfaces 180 may utilize any suitable radio access technology, and may be substantially similar to the air interfaces 190 over which the EDs 110a-110c communication with one or more of the base stations 170a-170c, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 180. In some embodiments, the SL air interfaces 180 may be, at least in part, implemented over unlicensed spectrum.

In this disclosure, the SL transmissions between cooperating UEs may be “grant-free” transmissions or as a mode for data transmissions that are performed without communicating dynamic scheduling. Grant-free transmissions are sometimes called “configured grant”, “grant-less”, “schedule free”, or “schedule-less” transmissions. Grant-free SL transmissions can also be referred to as SL “transmission without grant”, “transmission without dynamic grant”, “transmission without dynamic scheduling”, or “transmission using configured grant”, for example.

A configured grant transmission typically requires the receiver to know the parameters and resources used by the transmitter for the transmission. However, in the context of SL transmissions, the receiving UE is typically not aware of the transmitting UE's configuration parameters, such as which UE is transmitting, the ultimate target of the data (e.g., another UE), the time-domain and frequency-domain communication resources used for the transmission, and other control information. Various methods may be used to provide the configuration parameters and control information necessary for enabling configured grant transmissions in SL. The various methods will, however, each incur a respective overhead penalty. Embodiments of the present disclosure comprise including at least some of those configuration parameters and/or control information in the SL configured grant transmission, which may provide performance and/or overhead benefits.

In addition, some or all of the EDs 110a-110c may include functionality for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110c may be multimode devices capable of operation according to multiple radio access technologies, and incorporate multiple transceivers necessary to support multiple radio access technologies.

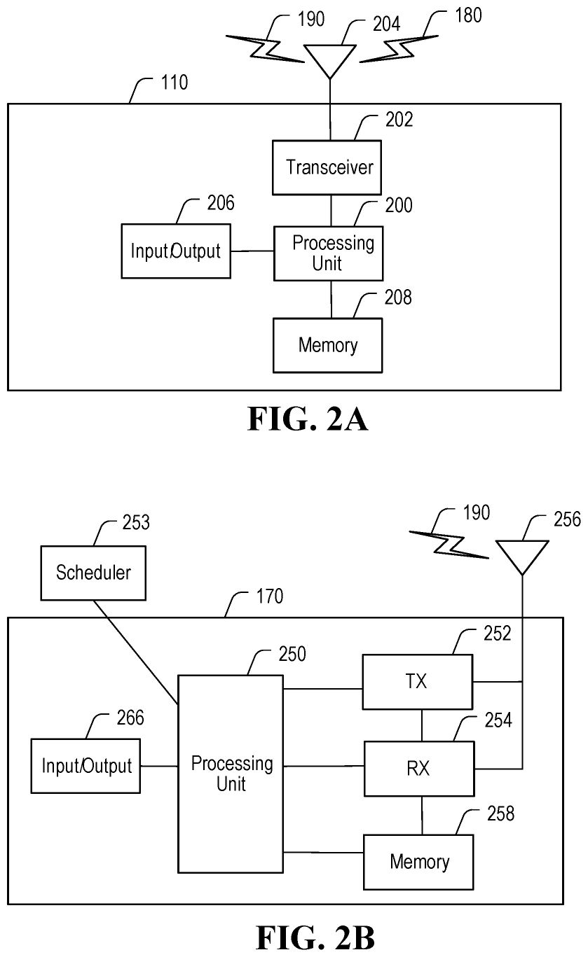

FIGS. 2A and 2B illustrate example devices that may implement the methods and teachings according to this disclosure. In particular, FIG. 2A illustrates an example ED 110, and FIG. 2B illustrates an example base station 170. These components could be used in the system 100 or in any other suitable system.

As shown in FIG. 2A, the ED 110 includes at least one processing unit 200. The processing unit 200 implements various processing operations of the ED 110. For example, the processing unit 200 could perform signal coding, bit scrambling, data processing, power control, input/output processing, or any other functionality enabling the ED 110 to operate in the communication system 100. The processing unit 200 may also be configured to implement some or all of the functionality and/or embodiments described in more detail herein. Each processing unit 200 includes any suitable processing or computing device configured to perform one or more operations. Each processing unit 200 could, for example, include a microprocessor, microcontroller, digital signal processor, field programmable gate array, or application specific integrated circuit.

The ED 110 also includes at least one transceiver 202. The transceiver 202 is configured to modulate data or other content for transmission by at least one antenna or Network Interface Controller (NIC) 204. The transceiver 202 is also configured to demodulate data or other content received by the at least one antenna 204. Each transceiver 202 includes any suitable structure for generating signals for wireless or wired transmission and/or processing signals received wirelessly or by wire. Each antenna 204 includes any suitable structure for transmitting and/or receiving wireless or wired signals. One or multiple transceivers 202 could be used in the ED 110. One or multiple antennas 204 could be used in the ED 110. Although shown as a single functional unit, a transceiver 202 could also be implemented using at least one transmitter and at least one separate receiver.

The ED 110 further includes one or more input/output devices 206 or interfaces (such as a wired interface to the internet 150). The input/output devices 206 permit interaction with a user or other devices in the network. Each input/output device 206 includes any suitable structure for providing information to or receiving information from a user, such as a speaker, microphone, keypad, keyboard, display, or touch screen, including network interface communications.

In addition, the ED 110 includes at least one memory 208. The memory 208 stores instructions and data used, generated, or collected by the ED 110. For example, the memory 208 could store software instructions or modules configured to implement some or all of the functionality and/or embodiments described above and that are executed by the processing unit(s) 200. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 2B, the base station 170 includes at least one processing unit 250, at least one transmitter 252, at least one receiver 254, one or more antennas 256, at least one memory 258, and one or more input/output devices or interfaces 266. A transceiver, not shown, may be used instead of the transmitter 252 and receiver 254. A scheduler 253 may be coupled to the processing unit 250. The scheduler 253 may be included within or operated separately from the base station 170. The processing unit 250 implements various processing operations of the base station 170, such as signal coding, bit scrambling, data processing, power control, input/output processing, or any other functionality. The processing unit 250 can also be configured to implement some or all of the functionality and/or embodiments described in more detail above. Each processing unit 250 includes any suitable processing or computing device configured to perform one or more operations. Each processing unit 250 could, for example, include a microprocessor, microcontroller, digital signal processor, field programmable gate array, or application specific integrated circuit.

Each transmitter 252 includes any suitable structure for generating signals for wireless or wired transmission to one or more EDs or other devices. Each receiver 254 includes any suitable structure for processing signals received wirelessly or by wire from one or more EDs or other devices. Although shown as separate components, at least one transmitter 252 and at least one receiver 254 could be combined into a transceiver. Each antenna 256 includes any suitable structure for transmitting and/or receiving wireless or wired signals. Although a common antenna 256 is shown here as being coupled to both the transmitter 252 and the receiver 254, one or more antennas 256 could be coupled to the transmitter(s) 252, and one or more separate antennas 256 could be coupled to the receiver(s) 254. Each memory 258 includes any suitable volatile and/or non-volatile storage and retrieval device(s) such as those described above in connection to the ED 110. The memory 258 stores instructions and data used, generated, or collected by the base station 170. For example, the memory 258 could store software instructions or modules configured to implement some or all of the functionality and/or embodiments described above and that are executed by the processing unit(s) 250.

Each input/output device 266 permits interaction with a user or other devices in the network. Each input/output device 266 includes any suitable structure for providing information to or receiving/providing information from a user, including network interface communications.

Additional details regarding the UEs 110 and the base stations 170 are known to those of skill in the art. As such, these details are omitted here for clarity.

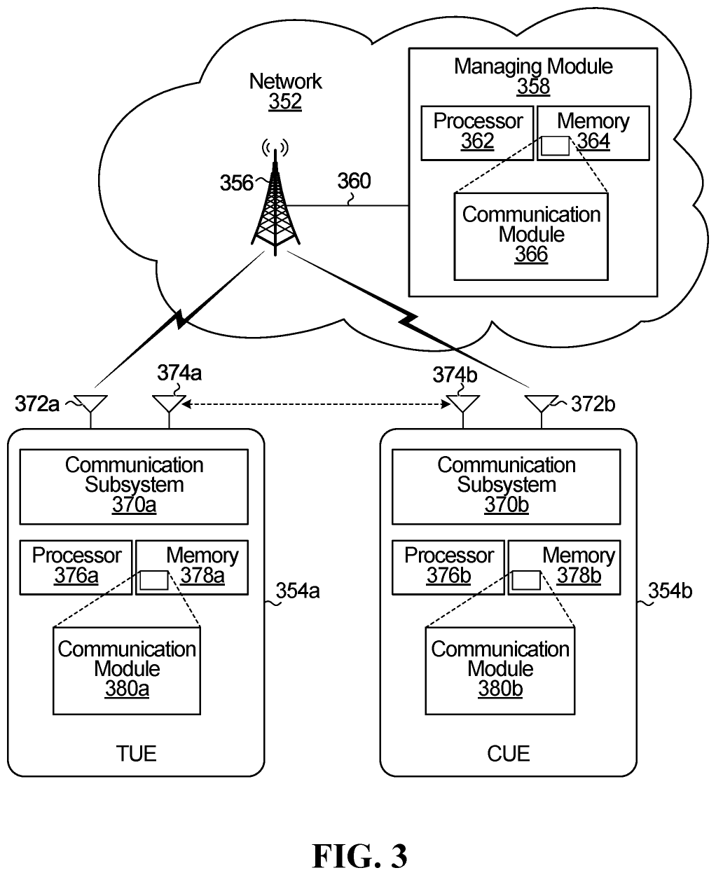

FIG. 3 is a block diagram illustrating an example of a network 352 serving two UEs 354a and 354b, according to one embodiment. The two UEs 354a and 354b may be, for example, the two UEs 110a and 100b in FIG. 1. However, more generally this need not be the case, which is why different reference numerals are used in FIG. 3.

The network 352 includes a BS 356 and a managing module 358. The managing module 358 instructs the BS 356 to perform actions. The managing module 358 is illustrated as physically separate from the BS 356 and coupled to the BS 356 via a communication link 360. For example, the managing module 358 may be part of a server in the network 352. Alternatively, the managing module 358 may be part of the BS 356.

The managing module 358 includes a processor 362, a memory 364, and a communication module 366. The communication module 366 is implemented by the processor 362 when the processor 362 accesses and executes a series of instructions stored in the memory 364, the instructions defining the actions of the communication module 366. When the instructions are executed, the communication module 366 causes the BS 356 to perform the actions described herein so that the network 352 can establish, coordinate, instruct, and/or control a UE group. Alternatively, the communication module 366 may be implemented using dedicated circuitry, such as an application specific integrated circuit (ASIC) or a programmed field programmable gate array (FPGA).

The UE 354a includes a communication subsystem 370a, two antennas 372a and 374a, a processor 376a, and a memory 378a. The UE 354a also includes a communication module 380a. The communication module 380a is implemented by the processor 376a when the processor 376a accesses and executes a series of instructions stored in the memory 378a, the instructions defining the actions of the communication module 380a. When the instructions are executed, the communication module 380a causes the UE 354a to perform the actions described herein in relation to establishing and participating in a UE group. Alternatively, the module 380a may be implemented by dedicated circuitry, such as an ASIC or an FPGA.

The communication subsystem 370a includes processing and transmit/receive circuitry for sending messages from and receiving messages at the UE 354a. Although one communication subsystem 370a is illustrated, the communication subsystem 370a may be multiple communication subsystems. Antenna 372a transmits wireless communication signals to, and receives wireless communications signals from, the BS 356. Antenna 374a transmits SL communication signals to, and receives SL communication signals from, other UEs, including UE 354b. In some implementations there may not be two separate antennas 372a and 374a. A single antenna may be used. Alternatively, there may be several antennas, but not separated into antennas dedicated only to SL communication and antennas dedicated only to communicating with the BS 356.

SL communications could be over Wi-Fi, in which case the antenna 374a may be a Wi-Fi antenna. Alternatively, the SL communications could be over Bluetooth™, in which case the antenna 374a may be a Bluetooth™ antenna. SL communications could also or instead be over licensed or unlicensed spectrum.

The UE 354b includes the same components described above with respect to the UE 354a. That is, UE 354b includes communication subsystem 370b, antennas 372b and 374b, processor 376b, memory 378b, and communication module 380b.

The UE 354a is designated as a target UE (TUE) and will therefore be called TUE 354a. The UE 354b is a cooperating UE and will therefore be called CUE 354b. The CUE 354b may be able to assist with wireless communications between the BS 356 and TUE 354a if a UE group were to be established that included TUE 354a and CUE 354b.

UE 354a may be specifically chosen as the target UE by the network 352. Alternatively, the UE 354a may itself determine that it wants to be a target UE and inform the network 352 by sending a message to the BS 356. Example reasons why UE 354a may choose or be selected by the network 352 to be a target UE include: low wireless channel quality between the UE 354a and the BS 356, many packets to be communicated between the BS 356 and the UE 354a, and/or the presence of a cooperating UE that is a good candidate for helping with communications between the BS 356 and the UE 354a.

UE 354a need not always stay a target UE. For example, UE 354a may lose its status as a target UE once there is no longer a need or desire for assistance with wireless communications between UE 354a and the BS 356. UE 354a may assist another target UE that is a cooperating UE at a later time. In general, a particular UE may sometimes be a target UE and other times may be a cooperating UE assisting another target UE. Also, sometimes a particular UE may be both a target UE receiving assistance from one or more cooperating UEs and also a cooperating UE itself assisting another target UE.

FIG. 3 illustrates a system in which embodiments of the present disclosure could be implemented. In some embodiments, a UE includes a processor, such as 376a, 376b, and a non-transitory computer readable storage medium, such as 378a, 378b, storing processor executable instructions for execution by the processor. In some embodiments, a base station includes a processor, such as 362, and a non-transitory computer readable storage medium, such as 364, storing processor executable instructions for execution by the processor. These processor executable instructions could cause the UE and/or base station to perform any of the methods described herein. A non-transitory computer readable storage medium could also or instead be provided separately, as a computer program product.

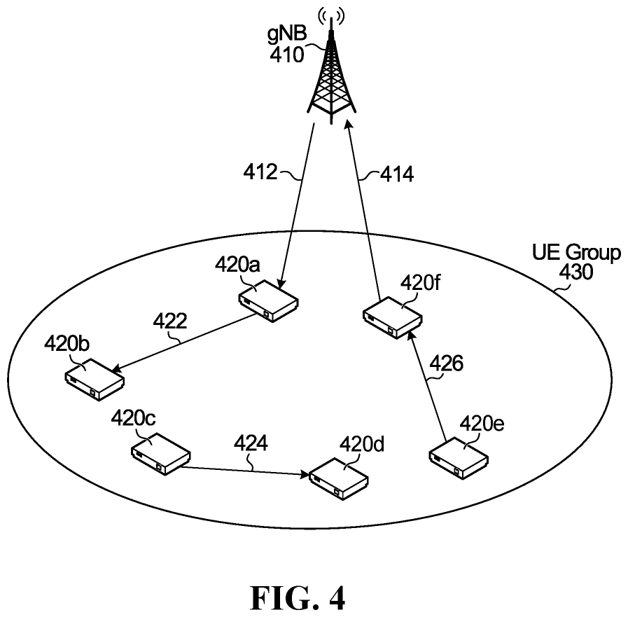

FIG. 4 illustrates three different types of packet transmissions that may occur between a base station and a group of UEs that are predefined as being in a same group. FIG. 4 includes a base station 410 and several UEs (420a, 420b, 420c, 420d, 420e and 420f that are part of UE group 430. The base station 410 can transmit and receive from UEs, for example as indicated by Uu downlink (DL) transmission 412 to UE 420a and by Uu uplink (UL) transmission 414 from UE 420f. The UEs can transmit and receive amongst themselves as indicated by sidelink (SL) transmission 422 between UE 420a and UE 420b, by SL transmission 424 between UE 420c and UE 420d and by SL transmission 426 between UE 420e and UE 420f.

To initiate UE cooperation, a UE group could be formed. The formation of a UE group could be based on geometry or some other criterion. During the UE cooperation, a base station could multicast the PDCCH to the UE group, which schedules the associated PDSCH to carry a packet. The packet could be intended for a particular UE or set of UEs in the group. The UEs in the group would first try to decode PDCCH and try to determine the target of the packet. If a UE determines that packet is not for itself but for other UE(s) in the group, it could forward the packet to those UE(s).

A CUE could forward a packet to a TUE on SL, which may or may not share the same band as the Uu link. If the SL and Uu link do share the same band, then the SL could be referred to as an in-band SL. If the SL uses a separate band from the Uu link, then the SL could be referred to as an out-band SL. Normally, the SL is shared by all the UEs in a UE group, and thus the UEs might only operate in the half-duplex mode. Time-frequency resources on the SL could be actively scheduled or pre-configured.

A packet could be scrambled with a UE specific ID or a UE group specific ID. In some cases, a cyclic redundancy check (CRC) of a packet could be scrambled or masked by a radio network temporary identifier (RNTI) of a TUE. For example, the RNTI bits could be used to mask the CRC bit-field. In such cases, only the UEs that know the TUE RNTI could be able to decode the packet, de-mask the CRC bits, and use the CRC to check if the decoding was successful. Other UEs might not be able to de-mask the CRC bits if they do not know the TUE RNTI. The TUE RNTI could be made available to all of the UEs in the UE group, only some of UEs in the UE group, or none of the UEs in the UE group except for the TUE itself. To randomize and/or whiten the interference produced by a packet, the encoded bits (for example, information bits and CRC bits) could be scrambled bit-by-bit by a scrambling sequence initiated by at least one of the TUE RNTI, higher layer configured ID and/or an ID of a serving cell. The configured ID is an identifier that could be configured by a base station and told to the UE. Therefore, the UE could know the configured ID. The packet should be descrambled before it is decoded, and therefore this scrambling also helps to prevent other UEs decoding the packet if they do not know the TUE's RNTI. When a packet is scrambled using a TUE RNTI, the TUE RNTI could be considered the key in UE cooperation that determines whether a CUE is able to decode the packet for the TUE or not.

In some cases, the CRC of a packet could be scrambled or masked by a RNTI of a UE group, and the encoded bits (information bits and CRC bits) could be scrambled bit-by-bit by a scrambling sequence initiated by the UE group specific RNTI. In these cases, each UE in the UE group knows the UE group specific RNTI, and could be able to decode the packet, de-mask the CRC bits, and use the CRC to check if the decoding was successful.

There are a number of different types of RNTIs. For example, an RNTI could be a cell RNTI (C-RNTI), a modulation coding scheme C-RNTI (MCS-C-RNTI), or a configured scheduling RNTI (CS-RNTI). In some embodiments, a UE specific RNTI and/or a UE group specific RNTI could be a C-RNTI.

UE cooperation could support several types of transmissions. One type of transmission in UE cooperation is from a base station to a UE in a predefined UE group. The base station sends a packet on the Uu DL by multicasting to a group of UEs. The CRC of the packet can be scrambled by a TUE specific ID or the UE group specific ID. The UEs in the group could receive the packet and identify a destination for the packet, i.e., the TUE. The UEs could determine the destination of the packet based on control information previously received by the UEs, for example. If the packet is not for the UE, the UE can forward the packet through amplify and forward (AF), decode and forward (DF) or quantize and forward (QF) methods. In some embodiments, the packet is forwarded using grant free (GF) transmission, also known as configured grant transmission. If a UE receives the packet and identifies that it is the TUE, then the UE can decode the packet. The TUE can identify a source of the packet and send a Hybrid-Automatic Repeat Request (HARQ) acknowledgement (ACK) to the source, either directly or via one or more CUE(s).

Another type of transmission in UE cooperation is between UEs within the UE group. The UE(s) in the UE group can send a packet using the SL to another UE. In some embodiments, this may include using a configured grant transmission. The CRC of the packet can be scrambled by a TUE specific ID or the UE group specific ID. The UEs in the UE group can receive the packet and identify a destination for the packet. If the packet is not for the UE, the UE can forward the packet through AF, DF or QF methods. In some embodiments, the packet is forwarded using configured grant transmission. If the UE receives and identifies that it is the TUE, then the UE can decode the packet. The TUE can identify a source of the packet and send a HARQ ACK to the source, either directly or via one or more CUE(s).

A further type of transmission in UE cooperation is from a UE in a predefined UE group to a base station. If the UE knows, or can determine, that the UE is within the coverage area of the Uu UL, then the UE can send the packet directly to the base station using the Uu UL. In some embodiments, the packet is transmitted using configured grant transmission. If the UE in the UE group knows, or can determine, that the UE is not within the coverage area of the Uu UL, then the UE sends the packet using the SL to one or more UE(s). In some embodiments, the packet is transmitted using configured grant transmission. The CRC of the packet can be scrambled by a base station identifier, a cell identifier and/or the UE group specific ID. The UEs in the UE group can receive the packet and identify a destination for the packet. The UEs in the UE group can forward the packet through AF, DF or QF methods. If the UE receives the packet and identifies that the packet is for the base station, and the UE is within the coverage area of Uu UL, then the UE can transmit the packet directly to the base station using Uu UL. In some embodiments, the packet is transmitted using configured grant transmission.

The packets in these types of transmissions could carry one or a combination of data and control information from lower or higher layers.

UE cooperation could include strategies for handling degraded channel signals. For example, one or more CUEs could perform the AF, DF and/or QF methods to support communications for one or more TUEs in the group of UEs. The strategies for degraded channel signals also include hierarchical modulation and/or coding. For example, a CUE receives and decodes a first modulated signal on a downlink and then forwards the first signal to a TUE, which also directly receives and decodes a second modulated signal (via a direct link from a BS). The TUE then combines the first and second signals to process the downlink data. This is referred to as soft combining. Similarly, two modulated signals (or more) on the uplink can be separately received by the network from a CUE and a TUE and then combined for processing.

UE cooperation could also include strategies for handling non-degraded channel signals. Such strategies include joint reception on the DL between one or more CUE(s) and one or more TUE(s) in the group of UEs, for example using log-likelihood ratio (LLR) combining or multiple-input and multiple-output MIMO (MIMO) schemes. The strategies for non-degraded channel signals also include joint transmission on the uplink between one or more TUEs and one or more CUEs, such as using Eavesdrop or HARQ schemes.

CUEs and TUEs may switch between any of the UE cooperation strategies above based on the network channel conditions, for example, according to whether degraded or non-degraded channel signals are detected. In an embodiment, a CUE estimates a channel between the CUE and the network and forwards the estimated channel to a corresponding TUE. The TUE also estimates a channel between the TUE and the network, and then combines the channels to obtain a combined channel for joint reception/transmission.

In some embodiments of the present disclosure, as part of a UE cooperation process, a packet destination identifier, or packet destination ID for simplicity, is used to facilitate the forwarding of packets. The packet destination ID is used to indicate a final destination of the packet, i.e., the TUE. The packet destination ID can be transmitted in any of a number of different ways. The packet destination identifier is a relative identifier for the UE. It is intended for use when a UE is part of a group for UEs, and in particular for UE cooperation. The packet destination identifier may be seen as a specific identifier with respect to the group of UEs. For example, if a group of UEs includes ten UEs, UE #1 could be assigned index #1, UE #2 could be assigned index #2, and so on. As a number of UEs in the group is typical a low number, the indices of the UEs can be captured by a bit length of, for example (but not intended to be limiting), 3 to 8 bits. In a particular example, 3 bits could be used to indicate a UE index for each UE in a group of eight UEs. The packet destination identifier is different from the UE specific RNTI, which is a global UE specific identifier. The packet destination identifier could be provided to other UEs in the group, without having to disclose the UE specific RNTI to other UEs. This has the benefit of lower overhead because of the small bit length of the packet destination identifier, as well as increased privacy because other UEs in the group are not provided with an explicit identifier of the UE, only a relative identifier of the packet destination. In some embodiments, the packet destination ID is embedded in the data portion or the control information portion, or both, in the format of a self-contained bit field or code block. A bit combination could indicate one or multiple UE(s) in a UE group. For example, the bit combination may identify each UE using an index value associated with the UE that has been assigned within the UE group. If there were eight UEs in the UE group, a three bit combination could be used to identify each of the UEs. Alternatively, in some embodiments, a bit map could be used to indicate the UE index in a UE group. For example, if there are eight UE in the UE group, an eight-bit bit map could be used to identify one or multiple UE in the group as the TUE.

In some embodiments, the packet destination ID is embedded in the data portion in a format of one of a set of self-contained sequences. In some embodiments, a single sequence in each set of sequences is used to identify one or multiple of the UEs in the UE group.

In some embodiments, the packet destination ID can be used to scramble demodulation reference signal (DMRS) sequences. In such a scenario, the packet destination identifier may be used to initiate a scrambling function to generate a DMRS sequence. As such, it may be possible to determine the packet destination ID from the DMRS sequence.

In some embodiments, the packet may also include a packet source identifier (ID) to indicate an original source of the packet, such as a base station or CUE. In some embodiments, the packet source ID is a relative and possibly temporary identifier in much the same way as the packet destination ID. When setting up the group of cooperating UEs, the base station may designate itself an index value to be included in the group. This index value could then be used as the packet source ID when the base station is the source of the packet. When a UE of the group of cooperating UEs is a source of the packet, the index designated by the base station for the UE can be used as the packet source ID. The packet source ID can be transmitted similarly to the packet destination ID, for example as a bit field or code block, a sequence, or a DMRS sequence.

In some embodiments, the packet destination ID and the packet source ID use different resources. For example, different bit fields, different code blocks, different sequences, and/or different scrambling sequences for the DMRS. Alternatively, the packet destination ID and the packet source ID could be coded jointly.

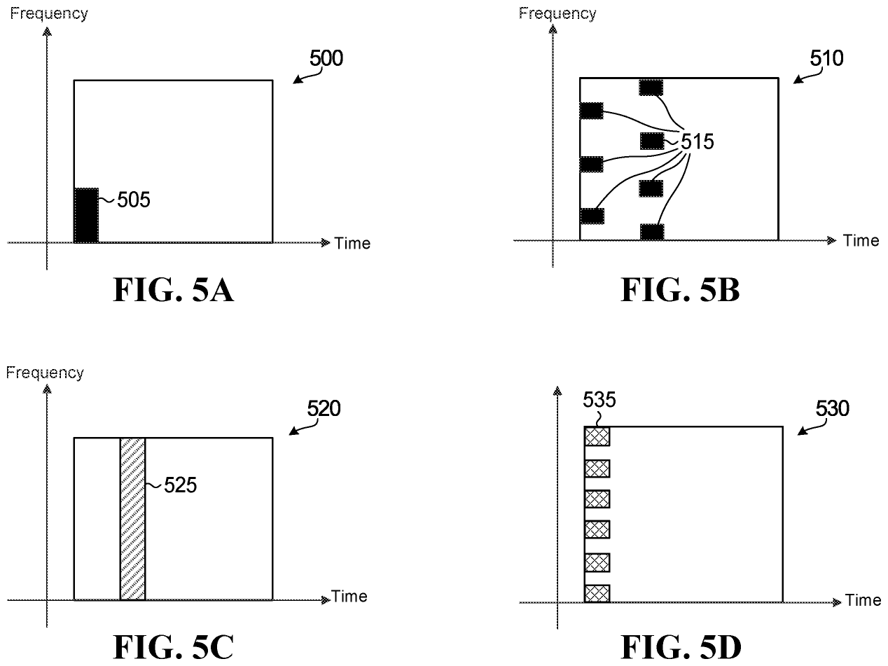

FIGS. 5A, 5B, 5C and 5D are plot diagrams illustrating several different examples of how the packet destination ID and the packet source ID could be transmitted.

Each of FIGS. 5A, 5B, 5C and 5D illustrate a representation of a two dimensional time-frequency resource. Time is along the x-axis and frequency is along the y-axis. The time-frequency resource may be used for transmitting both data and control information.

FIGS. 5A and 5B show that the packet destination ID, or the packet source ID, could be located in the data portion of the resource. In some embodiments, the packet destination ID, and/or the packet source ID, may be within the physical downlink shared channel (PDSCH). The bit field or code block could either be localized in a single location 505 of a resource 500, as shown in FIG. 5A, or distributed within multiple portions 515 of a resource 510, as shown in FIG. 5B. The bits that indicate the packet destination ID or the packet source ID could be either coded or not coded. If coded, the packet destination ID or the packet source ID could be located in a code block all together, as shown in FIG. 5A, or distributed in the data part, as shown in FIG. 5B. In a scenario when the code block is localized, the code block could be located at the beginning of the data portion, such as in a first physical resource block (PRB) and a first symbol. In a scenario when the code block is distributed, the code block bits could be spread over a first symbol or across multiple symbols in a slot. In some embodiments, puncturing or rate matching could be applied to the data portion when the packet destination ID, or the packet source ID, is multiplexed into the data portion.

FIG. 5C shows an example in which one of a set of sequences can be used to indicate either of a packet destination ID or packet source ID. The sequence 525 is located in a resource 520. While the sequence 525 is shown to encompass a symbol over the entire bandwidth of the resource, this is only an example and it is to be understood that the sequence may encompass less than the entire bandwidth and may occur over multiple symbols. An example of a type of sequence is a Zadoff-Chu (ZC) sequence, but other types of sequences are also contemplated. Different sequences could be used to indicate respective packet destination IDs or source packet IDs. The sequence may be transmitted before a data portion or inserted into the data portion. The sequence may span a whole symbol or a portion of one or more symbols. In some embodiments, puncturing or rate matching could be applied to the data portion when the sequence is multiplexed into the data portion.

FIG. 5D shows an example of how a DMRS 535 could be used to indicate either the packet destination ID or the source destination ID in a resource 530. Generating the scrambled DMRS could be initiated by the packet destination ID, or the packet source ID, and thus the packet destination, or the source destination, can be derived from the received DMRS.

In some embodiments, the packet destination ID or the packet source ID could be derived by one or more network parameters. A first example parameter is the target UE specific ID (for the packet destination ID) or the source UE specific ID (for the packet source ID). The target UE specific ID or the source UE specific ID may include a radio network temporary identifier (RNTI) or other higher layer configured identifier. A second example parameter is a target UE index or a source UE index of the UE group. A third example parameter is a UE group specific ID containing the target UE and/or the source UE. The UE group specific ID may also include a RNTI. A fourth example parameter is a different ID that is assigned to the target UE or the source UE by the base station. A fifth example parameter is a HARQ process identifier (ID) of the transmission. A sixth example parameter is a cell ID or other identifier of the base station (or transmit receive point (TRP)) that is associated with the UE group on the Uu link.

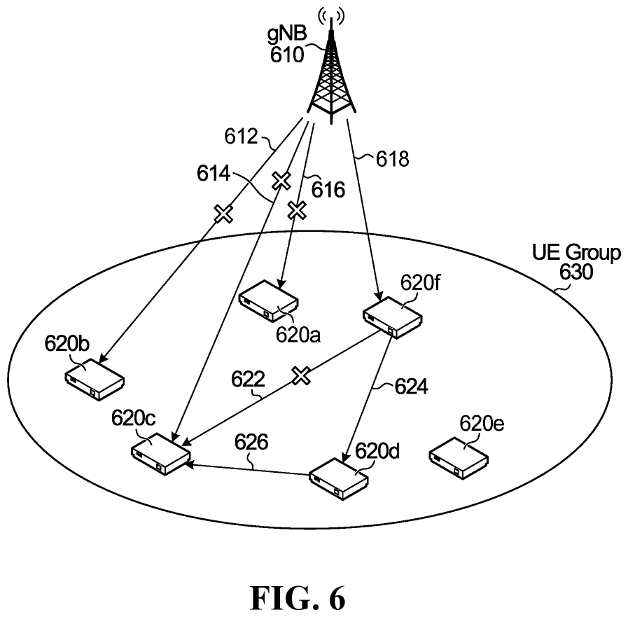

With the use of packet destination ID or packet source ID, the procedure of packet transmission in a UE group can be implemented as described below with reference to FIG. 6. FIG. 6 has a similar arrangement of network elements as FIG. 4, including a base station 610 and six UEs 620a, 620b, 620c, 620d, 620e and 620f in a predefined UE group 630. However, it is to be understood that this is simply an example arrangement and alternative arrangements with different number of UEs and sizes of UE groups are also contemplated.

A preliminary process that occurs, but is not discussed in detail, is the organization of the UE group 630. Once the group has been defined or formed, the base station 610 transmits a multicast message to the UEs of the group. This is shown in the form of multicast transmissions 612, 614, 616 and 618 from the base station 610 to UE 620b, UE 620c, UE 620a and UE 620f, respectively. Although the multicast transmissions 612, 614, 616 and 618 are identified using different reference characters, this is only for the purpose of describing the figure. It is to be understood that the each multicast transmissions 612, 614, 616 and 618 are the same. Multicast transmissions 612, 614, and 616 are not successfully received at UE 620b, UE 620c, UE 620a, respectively. The unsuccessful reception of a packet could mean that the UE does not detect the control channel that schedules the data packet. In this sense, UE 620b, UE 620c, UE 620a could be considered out-of-coverage UEs for the base station 610. However, multicast transmission 618 is successfully received at UE 620f. In this sense, UE 620f could be considered an in-coverage UE for the base station 610. After a packet is received by UE 620f, the UE 620f can identify whether the packet is for UE 620f or not, without decoding the entirety of packet. For example, the UE 620f could decode at least the portion of the packet that includes the packet destination identifier. If the packet is for UE 620f, the UE can try to decode the packet. If not, the UE 620f could forward the packet. In the example of FIG. 6, UE 620f determines that the packet is not for UE 620f and forwards the packet to other UEs, in this case UE 620c and UE 620d in SL transmissions 622 and 624, respectively. This could be performed using any of the AF, DF or QF methods described herein. Such procedure will be repeated until the packet destination UE receives the packet and decodes it. Packet forwarding transmission 622 is not successfully received at UE 620c. However, packet forwarding transmission 624 is successfully received at UE 620d. After the packet is received by UE 620d, the UE 620d can identify whether the packet is for UE 620d or not, without decoding the entirety of packet. UE 620d determines that the packet is not for UE 620d and forwards the packet to UE 620c in packet forwarding transmission 626. After the packet is received by UE 620c, the UE 620c identifies that the packet is for UE 620c. In some embodiments, the packet destination UE, in FIG. 6 this is UE 620C, determines the source of the packet by checking the packet source ID. The packet destination UE 620C can feedback a HARQ-ACK to another UE in the group or to the base station, according to the packet source ID.

Some aspects of the present disclosure relate to packet forwarding for UE cooperation. Packet forwarding for UE cooperation could include, for example, packet forwarding transmissions 622, 624 and 626 of FIG. 6.

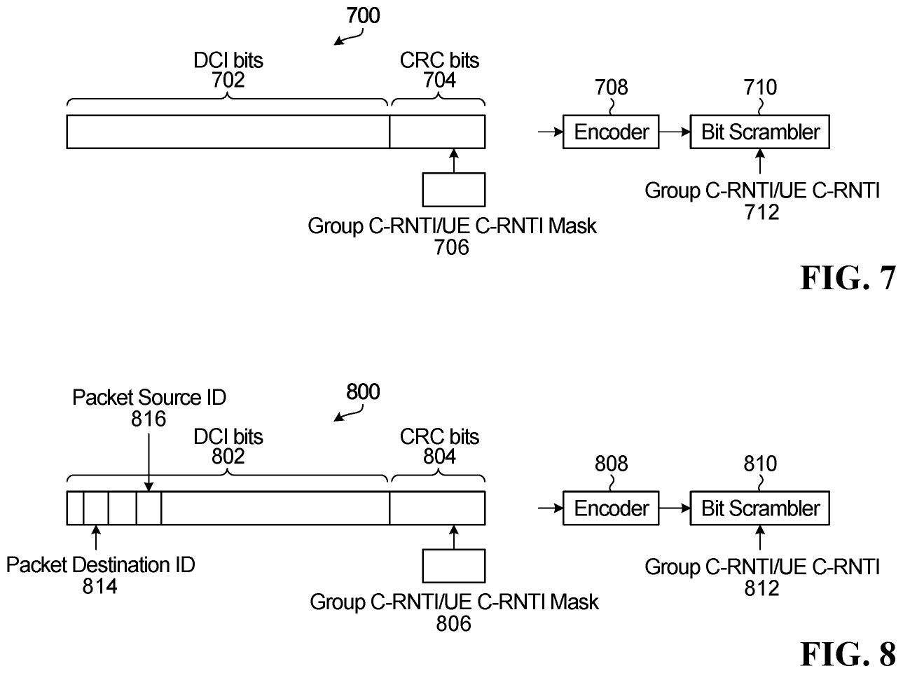

Transmissions to UEs in a UE group on the physical downlink control channel (PDCCH) could be scrambled with a group C-RNTI or a UE specific C-RNTI. For example, a group C-RNTI or a UE specific C-RNTI could be used for masking the CRC bits and scrambling the encoded bits (including the CRC bits) in a packet. FIG. 7 is a block diagram illustrating an example of scrambling a packet 700 for transmission on the PDCCH to one or more UEs in a UE group. The packet 700 could be transmitted by a base station on the DL, and at least a portion of the packet could subsequently be transmitted on the SL by a UE, for example. The packet 700 includes downlink control information (DCI) bits 702 and CRC bits 704. A mask 706 is applied to the CRC bits 704. The mask 706 could be a group C-RNTI mask for the UE group, or a UE specific C-RNTI mask. The packet 700 is then encoded at an encoder 708. The encoder 708 could include a polar encoder, a convolutional encoder, a turbo encoder and/or a low-density parity-check encoder, for example. Following the encoder 708, the bits of the packet (i.e., the encoded DCI bits 702 and CRC bits 704) are scrambled using a bit scrambler 710. The scrambling sequence that is used by the bit scrambler 710 is initiated by a C-RNTI 712, which could be a group C-RNTI or a UE specific C-RNTI. Following the bit scrambler 710, the packet 700 could be transmitted on the PDCCH to one or more UEs in the UE group.

The encoder 708 and/or the bit scrambler 710 could be components of a processing unit, and could be implemented in whole or in part in hardware, firmware, one or more components that execute software, or some combination thereof.

In some embodiments, the transmission on the PDCCH channel could be a multicast transmission using the group C-RNTI for the mask 706 and for the C-RNTI 712. The group C-RNTI could also be referred to as a multicasting C-RNTI. All the UEs in the UE group are informed or configured with the group C-RNTI, and therefore the UEs in the UE group could be able to decode the packets transmitted on the PDCCH. The PDCCH could transmit DCI that indicates the resources that will be used for the physical downlink shared channel (PDSCH), and therefore each UE in the UE group will know where the PDSCH will be transmitted.

The packet 700 could instead be scrambled using a UE specific C-RNTI. For example, a UE specific C-RNTI could be used for the mask 706 and for the C-RNTI 712. In these situations, the ability of a CUE to decode the packet 700 could depend on whether the CUE knows the UE specific C-RNTI.

In some embodiments, a packet that is transmitted on the PDCCH to UE(s) in a UE group could include a packet destination ID and/or a packet source ID. Packet destination IDs and packet source IDs are discussed in further detail elsewhere herein. FIG. 8 is block diagram illustrating an example of a packet 800 for transmission on the PDCCH to one or more UEs in a UE group. The packet 800 includes DCI bits 802 and CRC bits 804. The DCI bits 802 include a bit-field to indicate a packet destination ID 814 and another bit-field to indicate a packet source ID 816. The packet destination ID 814 could be a UE index for a TUE in the UE group or a base station ID. The packet source ID 816 could be a base station ID, a cell ID or a UE ID. Any UE in the UE group that receives the packet could check the bit-field to identify the packet destination and/or packet source after decoding the PDCCH. FIG. 8 also includes a group C-RNTI or UE specific C-RNTI mask 806, an encoder 808, a bit scrambler 810, and a group C-RNTI or a UE specific C-RNTI 812, which could be similar to the mask 706, encoder 708, bit scrambler 710, and C-RNTI 712 described above with reference to FIG. 7.

The PDCCH is an example of a channel that could carry a packet destination ID and/or a packet source ID. However, other channels could also or instead carry a packet destination ID and/or a packet source ID. For example, a packet destination ID and/or a packet source ID could also be carried by SL control information.

Transmissions to UEs in a UE group on the physical downlink shared channel (PDSCH) could be scrambled using two alternatives: a UE group specific C-RNTI or a UE specific C-RNTI. For example, a UE group specific C-RNTI or a UE specific C-RNTI could be used for masking the CRC bits and scrambling the encoded bits (including the CRC bits) in a packet. In the case that a TUE C-RNTI is used, a CUE might not be able to decode the PDSCH for the TUE if it does not know the C-RNTI of the TUE. If the CUE is informed of the TUE C-RNTI, the CUE could be able to decode the PDSCH for that TUE. In the case that a group C-RNTI is used, the CUE(s) in a UE group could be able to decode the PDSCH even if the PDSCH is intended for a particular TUE. Regardless of whether a UE specific C-RNTI or a UE group specific C-RNTI is used, higher layer encryption could be applied to a packet to maintain the confidentiality of TUE data even if a CUE can decode the packet at the physical (PHY) layer.

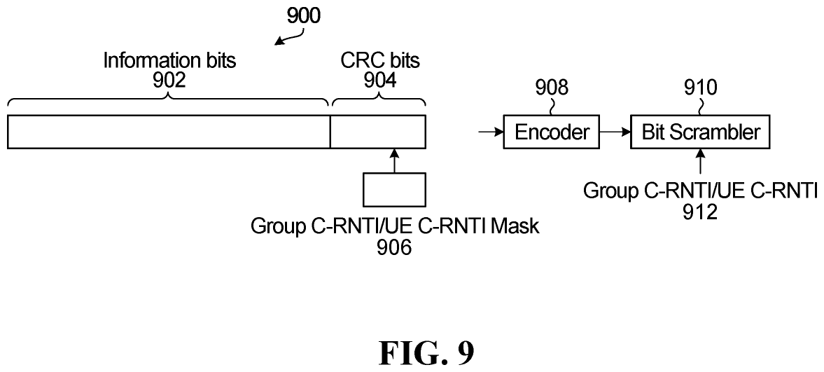

FIG. 9 is a block diagram illustrating an example of scrambling a packet 900 for transmission on the PDSCH to one or more UEs in a UE group. The packet 900 includes information bits 902 and CRC bits 904. A C-RNTI mask 906, which could be a UE group specific C-RNTI mask or a UE specific C-RNTI mask, is applied to the CRC bits 904. The packet 900 is then encoded at an encoder 908, which could be similar to the encoder 708 of FIG. 7, for example. Following the encoder 908, the information bits 902 and the CRC bits 904 of the packet 900 are scrambled using a bit scrambler 910, which could be similar to the bit scrambler 710 of FIG. 7, for example. The scrambling sequence that is used by the bit scrambler 910 is initiated by the C-RNTI 912. The C-RNTI 912 could be the group C-RNTI or the UE specific C-RNTI. The same C-RNTI (i.e., group C-RNTI or UE specific C-RNTI) could be used for both the C-RNTI mask 906 and the bit scrambler initiation input C-RNTI 912. Following the bit scrambler 910, the packet 900 could be transmitted on the PDSCH to one or more UEs in the UE group.

The ability of a CUE to decode a packet that is received on the PDSCH could depend on whether a group C-RNTI or a TUE C-RNTI is used to scramble the packet. If a TUE C-RNTI is used to scramble the packet, the ability of the CUE to decode the packet further depends on whether the CUE knows or is informed of the TUE C-RNTI. As such, the choice between using a group C-RNTI or a TUE C-RNTI to scramble a packet, and the choice between whether or not a CUE is informed of the TUE C-RNTI, could determine the decodability of packets on the PDSCH. For example, if privacy is desired, a packet transmitted on the PDSCH could be configured to be non-decodable by a CUE by using a TUE C-RNTI to mask the CRC bits and scramble the encoded bits in the packet, and not informing the CUE of the TUE C-RNTI.

In some embodiments, a packet could be scrambled with both a group C-RNTI and a TUE C-RNTI. For example, both the UE group specific C-RNTI and the TUE C-RNTI could be used to mask the CRC bits and scramble the encoded bits of a packet. In another example, one C-RNTI (the UE group specific C-RNTI or the TUE C-RNTI) could be used to mask the CRC bits of a packet, and the other C-RNTI could be used to scramble the encoded bits of a packet. In these embodiments, a UE should know both the group C-RNTI and the TUE C-RNTI to decode the packet.

The flexibility provided by the multiple different C-RNTIs (for example, TUE C-RNTI and group C-RNTI) could be complimented by the multiple different forwarding modes on the SL (for example, AF, DF and QF). In a sense, the multiple different forwarding modes could be considered to support the multiple different C-RNTIs, as a UE will be able to perform at least one of the multiple forwarding modes regardless of which C-RNTI is used to scramble the packet. In the case that a packet received over the PDSCH is scrambled with a TUE C-RNTI, a CUE will need to know the TUE C-RNTI to decode the packet. If a CUE does not know the TUE C-RNTI, the CUE will likely not be able decode the packet. However, the CUE could still know the destination of the packet. For example, the CUE may know the destination of the packet from DCI transmitted on the PDCCH. Therefore, the CUE could amplify and forward the packet on the SL (AF mode), or obtain quantized intermediate information regarding the packet and transmit the intermediate information on the SL (QF mode). In the case that a UE is able decode the packet, it could re-encode the packet and forward it on the SL (DF mode). The CUE could be able to decode the packet if the packet is scrambled with a TUE C-RNTI and the CUE knows the TUE C-RNTI, or if the packet is scrambled with a group C-RNTI. The CUE could determine the destination of a packet it receives from by a packet destination ID. In some cases, a UE might not know the destination of a packet that is received. However, the UE might know that the packet is not for itself because the UE cannot decode the packet. In such cases, the UE could still forward the packet on the SL.

Although the packets 700, 800 and 900 illustrated in FIGS. 7 to 9 are described in the context of transmissions to one or more UEs in a UE group, the same or similar packets could also be used for transmissions from a UE in a UE group to a base station. For example, the destination of the packet 700 could be a base station. The packet 700 could originate from a UE in a UE group, and one or more CUEs in the UE group could forward the packet 700 to the base station.

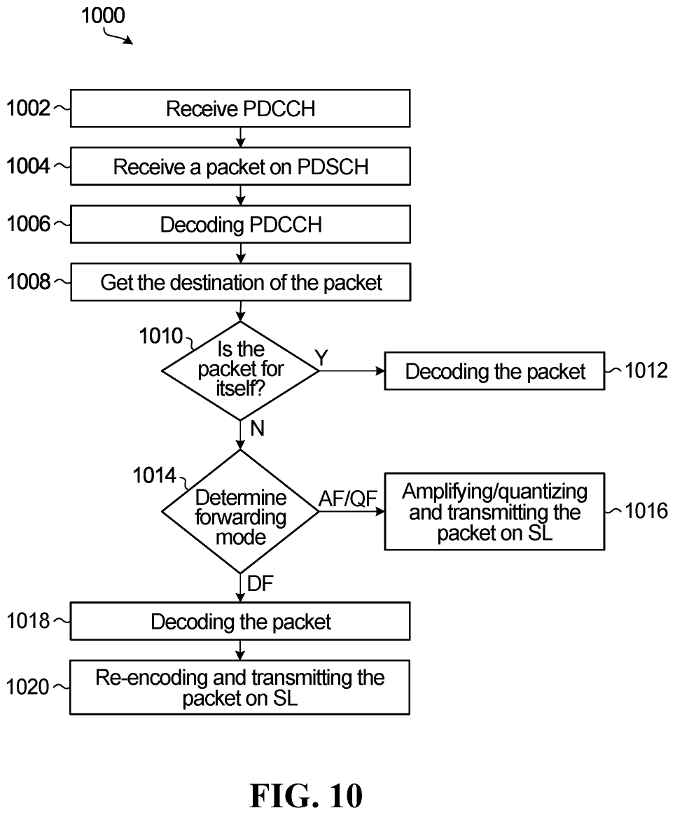

Referring now to FIG. 10, shown is a flow diagram illustrating an example method 1000 for UE cooperation on Uu link. The method 1000 could be performed by a UE in a predefined UE group. The method 1000 includes steps 1002, 1004, 1006, 1008, 1010, 1012, 1014, 1016, 1018 and 1020.

At step 1002 the UE receives the PDCCH, and at step 1004 the UE receives a packet on the PDSCH. The packet received on the PDSCH could be scrambled with an identifier, such as a UE specific C-RNTI or a group C-RNTI, by masking the CRC bits and/or scrambling the encoded bits using the identifier, for example.

Step 1006 includes decoding the PDCCH. The group C-RNTI could be used to descramble the PDCCH and allow the UE to decode the PDCCH. At step 1008, the UE determines the destination of the packet received on the PDSCH. The PDCCH could include DCI or other information that indicates the destination of the packet. Although steps 1002, 1004, 1006 and 1008 are illustrated in a particular order in FIG. 10, this is only an example. In general, steps 1002, 1004, 1006 and 1008 could be performed in any of a number of different orders.

Step 1010 is a decision step in which the UE determines if the packet is for itself. This decision could be based on the destination of the packet that was determined at step 1008. In the case that the packet is for the UE, the method 1000 proceeds to step 1012, in which the UE decodes the packet. The group C-RNTI or the C-RNTI of the UE could be used to scramble the packet. In either case, since the UE knows its own UE specific C-RNTI and the group C-RNTI, the UE could be able to decode the packet.

In the case that the destination of the packet is not the UE, the destination of the packet could be a TUE in the UE group. The UE could determine that the packet should be forwarded on the SL to the TUE, and the therefore the UE could act as a CUE. In this case, the method 1000 proceeds to step 1014. Step 1014 is a decision step in which the UE determines the forwarding mode to be used on the SL, which could include selecting a forwarding mode from multiple different forwarding modes (for example, the AF, DF and QF modes). In some embodiments, the UE could be informed that a certain forwarding mode should be used through signaling from a base station or other network entity. For example, the DCI or higher layer signaling could indicate or configure the forwarding mode to be used. If the signaling indicates that the AF mode or QF mode should be used for packet forwarding, the method 1000 proceeds to step 1016. If the signaling indicates that the DF mode should be used for packet forwarding, the method 1000 proceeds to step 1018.

In some embodiments, the UE might not be informed of a particular forwarding mode to be used. In these embodiments, the UE could select the forwarding mode based on the identifier used to scramble the packet. For example, step 1014 could include determining if the packet is scrambled with the TUE C-RNTI or the group C-RNTI, which could determine if the UE is able to decode the packet or not. Signaling from a base station or other network entity could inform the UE of the identifier that was used to scramble the packet. Alternatively, if the UE does not know which identifier is used to scramble the packet, the UE could attempt to decode the packet using the C-RNTIs that the UE knows. For example, the UE could attempt to decode the packet using the group C-RNTI. If the UE knows the C-RNTI of the TUE, the UE could also, or instead, attempt to decode the packet using the TUE C-RNTI.

If the packet is scrambled with the TUE C-RNTI and the UE does not know the TUE C-RNTI, then the UE could determine at step 1014 that the AF mode or QF mode should be used for packet forwarding. The choice between the AF mode and QF mode might be preconfigured at the UE, and/or the UE could receive signaling indicating that either the AF mode or QF mode should be used. The UE could also or instead determine whether to use the AF mode or QF mode using any of a number of different factors. The following is a non-limiting list of possible factors that a UE could use to determine if the AF mode or QF mode should be used:
channel quality measurements between the CUE and the base station;
channel quality measurements between the CUE and the TUE;
noise requirements; and
network resource limitations.

In the case that the UE determines that the AF mode or the QF mode should be used, the method 1000 proceeds to step 1016, which includes amplifying and/or quantizing the packet according to either the AF mode or the QF mode. Step 1016 further includes forwarding the packet on the SL to the TUE.

Referring again to step 1014, the UE could instead determine that the DF mode should be used for packet forwarding, and the method 1000 proceeds to step 1018. This could be the case when the packet is scrambled with the TUE C-RNTI and the UE knows the TUE C-RNTI, or if the packet is scrambled with the group C-RNTI. Step 1018 includes decoding the packet. The C-RNTI (either the group C-RNTI or the TUE C-RNTI) that was used to mask the CRC bits and/or scramble the encoded bits of the packet could be used by the UE to descramble the encoded bits and/or de-mask the CRC bits in order to correctly decode the packet. After the packet is decoded, the packet is re-encoded and transmitted on the SL to the TUE at step 1020.

In some embodiments, a UE could be configured with primary or preferred forwarding modes, and secondary or fallback forwarding modes. For example, a UE could be configured to use the DF mode when a packet should be forwarded. If the UE fails to decode the packet, the UE could use the AF mode or QF mode as a fallback mode to forward the packet. In this example, the primary forwarding mode is DF, and the secondary forwarding mode is AF or QF.

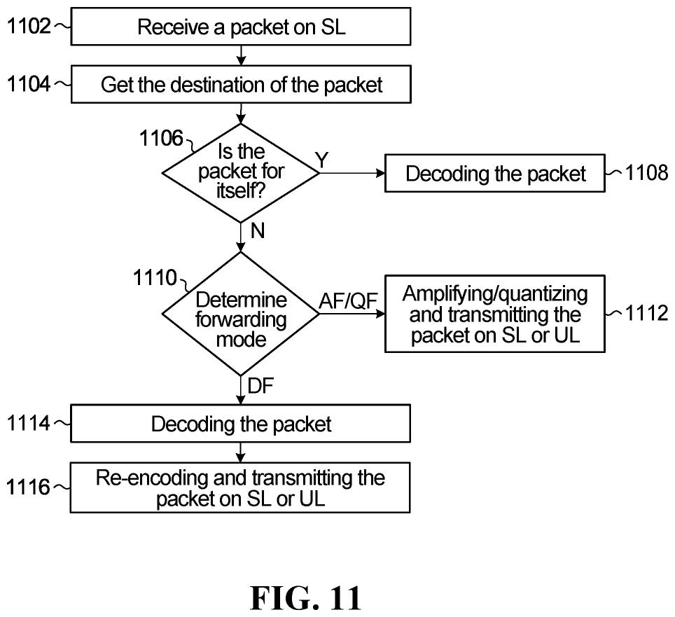

FIG. 11 is another flow diagram illustrating an example method 1100 for UE cooperation on the SL. The method 1100 could be performed by a UE in a predefined UE group. The method 1100 includes steps 1102, 1104, 1106, 1108, 1110, 1112, 1114 and 1116.

At step 1102, the UE receives a packet on the SL from another UE in the UE group. The packet could be scrambled with an identifier, such as a UE specific C-RNTI or a UE group specific C-RNTI, by masking the CRC bits and/or scrambling the encoded bits using the identifier, for example. At step 1104, the UE determines the destination of the packet. The destination of the packet could be indicated in DCI or other information such as sidelink control information (SCI) that the UE had previously received and decoded (not shown).

Step 1106 is a decision step in which the UE determines if the packet is for itself. This decision could be based on the destination of the packet that was determined at step 1104. In the case that the packet is for the UE, the method 1100 proceeds to step 1108 in which the UE decodes the packet. The UE group specific C-RNTI or the C-RNTI of the UE could be used for CRC masking and encoded bit scrambling in the packet. In either case, since the UE knows its own C-RNTI and the UE group specific C-RNTI, the UE could be able to decode the packet.

In the case that the destination of the packet is not the UE, the destination of the packet could be a TUE in the UE group or a base station. The UE could determine either that the packet should be forwarded on the SL to the TUE, or that the packet should be forwarded on the UL to the base station. In either case, the UE could act as a CUE and the method proceeds to step 1110. Step 1110 is a decision step in which the UE determines the forwarding mode to be used on the SL or UL, which could include selecting a forwarding mode from multiple different forwarding modes (for example, the AF, DF and QF modes). Determining a forwarding mode at step 1110 could be similar to determining a forwarding mode at step 1014 of FIG. 10.

If the UE determines that the AF mode or QF mode should be used for packet forwarding, the method 1100 proceeds to step 1112, which includes amplifying and/or quantizing the packet according to either the AF mode or the QF mode. Step 1112 further includes forwarding the packet on either the SL to a TUE, or on the UL to a base station.

If the UE instead determines that the DF mode should be used for packet forwarding, the method 1100 proceeds to step 1114. Step 1114 includes decoding the packet. The C-RNTI (either the UE group specific C-RNTI or the TUE C-RNTI) that was used to mask the CRC bits and/or scramble the encoded bits of the packet could be used by the UE to descramble the encoded bits and/or de-mask the CRC bits in order to correctly decode the packet. Once the packet is decoded, the packet is re-encoded and transmitted either on the SL to the TUE or on the UL to the base station at step 1116.

FIGS. 10 and 11 outline example procedures on the Uu link and SL, which could define UE behavior on the Uu link and SL. These procedures could help to facilitate UE cooperation, and potentially avoid ambiguity and confusion.

Multiple packets that are scrambled using different IDs could be transmitted and/or received by a single device in the network. In some embodiments, multiple packets could be transmitted by a base station on the PDCCH or PDSCH. In some embodiments, multiple packets could be transmitted and/or forwarded by a UE on the UL or SL. In some embodiments, multiple packets could be received by a base station on the UL. In some embodiments, multiple packets could be received by a UE on the SL, PDCCH or PDSCH. The multiple packets could include at least one packet scrambled using a UE group specific identifier such as a UE group specific C-RNTI, and at least one other packet scrambled using a UE specific identifier such as a UE specific C-RNTI. Therefore, a UE or base station could use different identifiers for the transmission or reception of different packets on the same channel. This could help provide flexibility in terms of data privacy requirements, noise management, and network resource limitations.

In some situations, a CUE could receive multiple packets and determine that two or more of these packets should be forwarded on the SL and/or UL. However, the CUE might have limited time-frequency resources with which to perform the forwarding. For example, multiple packets might need to be forwarded on the same time-frequency resources. A CUE also, or instead, might not have enough available battery power to forward all of the packets. As such, a need exists for methods of establishing rules for transmitting multiple packets.

Some aspects of the present disclosure relate to priority rules that can be set, pre-defined and/or configured to facilitate forwarding multiple packets on the SL and/UL. These priority rules could determine a relative priority for each packet waiting to be forwarded, and forward the packets based on their respective priorities. The packets with the highest priorities could be forwarded first, and the packets with lower priorities could be dropped (i.e., not forwarded at all) or delayed (i.e., forwarded at a later time). Delaying a packet could include waiting until the packet has the highest priority of all of the other packets still waiting to be forwarded by the UE. If a packet has not been forwarded after a predefined time, the packet could be dropped. In some embodiments, packets could be forwarded in an order that is based on their respective priorities.

Priority rules could help avoid confusion and/or ambiguity among UEs in a UE group. Priority rules could be configured to a UE or UEs using higher layer signaling, for example. The priority rules could be explicitly and/or implicitly indicated.

In some cases, a CUE could have multiple packets waiting to be forwarded to multiple different destinations. These destinations could include TUEs and base stations. The priority of each packet waiting to be forwarded could be determined based on a priority associated with the destination of that packet. In some embodiments, the priority of a packet is based on whether a destination of the packet is an out-of-coverage UE or an in-coverage UE. For example, an out-of-coverage TUE could have a higher priority that an in-coverage TUE. In some embodiments, the priority of a packet is based on a priority of a RNTI for the source or destination of the packet. For example, the RNTI of one or more UEs in a UE group could be associated with a priority, and the priority of a packet transmitted to and/or from a UE could be determined based on the priority associated with the RNTI for that UE. The RNTI of one UE could have a higher priority than others.

In some cases, a CUE could have multiple packets waiting to be forwarded, where two or more of the packets could be associated with different applications. Examples of these applications include enhanced mobile broadband (eMBB) and ultra-reliable low-latency communication (URLLC). A URLLC packet could be associated with a modulation coding scheme (MCS) that is selected from a MCS table. In some embodiments, the priority of a packet is based on whether the packet is or includes a URLLC packet. In some embodiments, the priority of a packet is based on whether the packet is or includes an eMBB packet. For example, a URLLC packet could have a higher priority than an eMBB packet. In some embodiments, the priority of a packet is based on an MCS table associated with the packet. For example, a URLLC packet could use a MCS from a first MCS table associated with higher reliability while an eMBB packet could use a MCS from a second MCS table associated with lower reliability. In this example, the URLLC packet could have a higher priority than the second eMBB packet.

In some cases, a CUE could have multiple packets waiting to be forwarded, where at least one of the packets is a re-transmission packet, and at least one of the packets is a first transmission packet. In some embodiments, the priority of a packet is based on whether the packet is or includes a re-transmission packet. For example, a re-transmission packet could have a higher priority than a first transmission packet.

Priority rules could provide guidance for a UE to follow when the UE needs to select a packet to forward at any given time, and there are multiple packets waiting to be forwarded on the same time-frequency resource and/or at the same time.

Various details of UE cooperation are described above. Method embodiments will now be described in further detail.

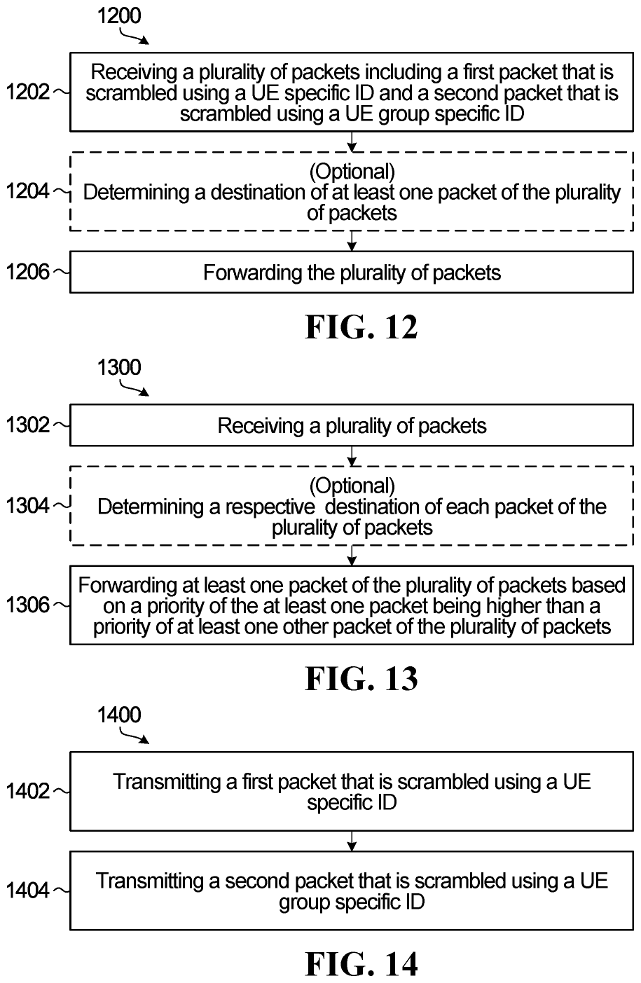

FIG. 12 is a flow diagram illustrating a method 1200 according to some embodiments. Method 1200 could be performed by a UE in a predefined UE group, for example. As shown at 1202, method 1200 includes receiving a plurality of packets including a first packet that is scrambled using a UE specific ID and a second packet that is scrambled using a UE group specific ID. An un-encoded version of the first packet could include cyclic redundancy check (CRC) bits that are masked using the UE specific identifier, and an un-encoded version of the second packet could include cyclic redundancy check (CRC) bits that are masked using the UE group specific identifier. The UE specific identifier could include at least one of a UE radio network temporary identifier (RNTI) and a configured identifier, and the UE group specific identifier could include a UE group specific RNTI. In some embodiments, the UE that receives the plurality of packets is a first UE, the UE specific identifier is associated with a second UE in the UE group, and the UE group specific identifier is associated with the UE group. Receiving the plurality of packets could include receiving at least one packet of the plurality of packets on a downlink channel from a base station and/or receiving at least one packet of the plurality of packets on a sidelink (SL) channel. The downlink channel could include a physical downlink shared channel (PDSCH) or a physical downlink control channel (PDCCH). In some embodiments, at least one packet of the plurality of packets includes data that is encrypted by higher layers.

As shown at 1204, method 1200 optionally includes determining a destination of at least one packet of the plurality of packets. Determining the destination of the at least one packet might include determining that the destination of the at least one packet is not the UE. In some embodiments, the at least one packet includes a packet destination identifier. As such, determining the destination of the at least one packet could include determining the destination of the at least one packet using the packet destination identifier. For example, the at least one packet could be associated with downlink control information (DCI), and the DCI could include the packet destination identifier. The DCI could also or instead include a packet source identifier.

As shown at 1206, method 1200 includes forwarding the plurality of packets. Forwarding the plurality of packets could include amplifying the first packet and transmitting the amplified first packet. Alternatively, forwarding the plurality of packets could include decoding the first packet, re-encoding the first packet, and transmitting the re-encoded first packet. Alternatively, forwarding the plurality of packets could include determining intermediate information of the first packet and transmitting the intermediate information. Similar comments also apply to the second packet of the plurality of packets. The intermediate information could include soft demodulated symbols, for example. Decoding the first or second packet could include descrambling the first or second packet using the UE specific identifier or UE group specific identifier, for example. Transmitting the re-encoded first or second packet could include transmitting a different redundancy version of the re-encoded first or second packet. Forwarding the plurality of packets at 1206 could include forwarding at least one packet of the plurality of packets on a sidelink channel to the second UE and/or forwarding at least one packet of the plurality of packets on an uplink channel to a base station.

The plurality of packets received at 1202 could be associated with respective priorities. For example, the first packet could be associated with a first priority and the second packet could be associated with a second priority different from the first priority. When the first priority is higher than the second priority, forwarding the second packet could be delayed by forwarding the first packet. When the first priority is lower than the second priority, forwarding the first packet could be delayed by forwarding the second packet. In some embodiments, the plurality of packets further could include a third packet associated with a third priority lower than the first priority and the second priority, and method 1300 could include dropping the third packet. The priority associated with a packet could be based on any of a number of factors. For example, a priority of at least one packet of the plurality of packets received at 1202 could be based on any or all of the following:
a priority of a radio network temporary identifier (RNTI) associated with the at least one packet;
whether a destination of the at least one packet is an out-of-coverage UE;
whether the at least one packet includes an ultra-reliable low-latency communication (URLLC) packet;
whether the at least one packet includes an enhanced mobile broadband (eMBB) packet;
whether the at least one packet includes a re-transmission packet; and
a modulation coding scheme (MCS) associated with higher reliability transmission for the at least one packet.

FIG. 13 is a flow diagram illustrating a method 1300 according to some embodiments. Method 1300 could be performed by a UE in a predefined UE group, for example. At 1302, method 1300 includes receiving a plurality of packets. At 1304, method 1300 optionally includes determining a respective destination of each packet of the plurality of packets. At 1306, method 1300 includes forwarding at least one packet of the plurality of packets based on a priority of the at least one packet being higher than a priority of at least one other packet of the plurality of packets. Packet priority could be based on any of the factors described above with reference to FIG. 12. The at least one packet and the at least one other packet could be designated to be forwarded on a same time-frequency resource. Forwarding the at least one packet could be based on a transmit power that is available to the UE. For example, the UE might not have enough available battery power to forward all of the plurality of packets received at 1302. In some embodiments, the at least one packet that is received at 1302 is dropped. In some embodiments, forwarding the at least one packet includes forwarding a first packet and a second packet of the plurality of packets, wherein a priority of the first packet is higher than a priority of the second packet, and wherein forwarding the second packet is delayed by forwarding the first packet. The first packet and the second packet could be designated to be forwarded on a same time-frequency resource. The forwarding at 1306 could be performed on a sidelink channel. For example, the at least one packet could be forwarded on the sidelink channel to another UE in the UE group.

FIG. 14 is a flow diagram illustrating a method 1400 according to some embodiments. Method 1400 could be performed by a base station, for example. At 1402, method 1400 includes transmitting a first packet that is scrambled using a UE specific ID, the UE specific ID being associated with a UE in a predefined UE group. The UE specific ID could include a UE specific RNTI. The first packet could include first CRC bits that are masked using the UE specific ID. The first packet could further include data that is encrypted. The first packet could be associated with DCI, and the DCI could include at least one of a packet destination identifier and a packet source identifier. The first packet could be transmitted on the PDCCH or the PDSCH. The first packet could be transmitted to the UE associated with the UE specific ID. The first packet could also or instead be received by another UE in the UE group and forwarded to the UE associated with the UE specific ID.

At 1404, method 1400 includes transmitting a second packet that is scrambled using a UE group specific ID, the UE specific ID being associated with the UE group. The second packet could include second CRC bits that are masked using the UE specific ID. The second packet could further include data that is encrypted. The first packet could be associated with DCI, and the DCI could include at least one of a packet destination identifier and a packet source identifier. The second packet could be transmitted on the PDCCH or the PDSCH. The UE group specific identifier could include a UE group specific RNTI. The second packet could be transmitted to the UE associated with the UE specific ID, and could then be forwarded to another UE in the UE group. The second packet could also or instead be received by another UE in the UE group and forwarded to the UE associated with the UE specific ID.

It should be appreciated that one or more steps of the embodiment methods provided herein may be performed by corresponding units or modules. For example, a packet may be transmitted by a transmitting unit or a transmitting module. A packet may be received by a receiving unit or a receiving module. A packet may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Various example methods and apparatus for data forwarding in UE cooperation are provided below.

According to one example, there is provided a method including receiving, by a UE in a predefined UE group, a plurality of packets. The plurality of packets includes a first packet that is scrambled using a UE specific identifier, and a second packet that is scrambled using a UE group specific identifier. The method further includes forwarding, by the UE, the plurality of packets.

In some implementations, the UE specific identifier is associated with a second UE in the UE group, and the UE group specific identifier is associated with the UE group. In some implementations, the UE specific identifier includes at least one of a UE specific radio network temporary identifier (RNTI) and a configured identifier, and the UE group specific identifier includes a UE group specific RNTI.

In some implementations, forwarding the plurality of packets includes: amplifying the first packet and transmitting the amplified first packet; decoding the first packet, re-encoding the first packet, and transmitting the re-encoded first packet; or determining intermediate information of the first packet and transmitting the intermediate information. In some implementations, decoding the first packet includes descrambling the first packet using the UE specific identifier. In some implementations, transmitting the re-encoded first packet includes transmitting a different redundancy version of the re-encoded first packet. In some implementations, the intermediate information includes soft demodulated symbols.

In some implementations, forwarding the plurality of packets further includes: amplifying the second packet and transmitting the amplified second packet; decoding the second packet, re-encoding the second packet, and transmitting the re-encoded second packet; or determining intermediate information of the second packet and transmitting the intermediate information. In some implementations, decoding the second packet includes descrambling the second packet using the UE group specific identifier. In some implementations, transmitting the re-encoded second packet includes transmitting a different redundancy version of the re-encoded second packet. In some implementations, the intermediate information includes soft demodulated symbols.

In some implementations, the method further includes determining a destination of at least one packet of the plurality of packets. In some implementations, determining the destination of the at least one packet includes determining that the destination of the at least one packet is not the UE that received the at least one packet. In some implementations, the at least one packet includes a packet destination identifier, and determining the destination of the at least one packet includes determining the destination of the at least one packet using the packet destination identifier.

In some implementations, the at least one packet is associated with downlink control information (DCI), and the DCI includes at least one of the packet destination identifier and a packet source identifier.

In some implementations, forwarding the plurality of packets includes forwarding at least one packet of the plurality of packets on a sidelink channel to the second UE. In some implementations, forwarding the plurality of packets includes forwarding at least one packet of the plurality of packets on an uplink channel to a base station.

In some implementations, receiving the plurality of packets includes receiving at least one packet of the plurality of packets on a downlink channel from a base station. The downlink channel could include a physical downlink shared channel (PDSCH) or a physical downlink control channel (PDCCH). In some implementations, receiving the plurality of packets includes receiving at least one packet of the plurality of packets on a sidelink channel.

In some implementations, an un-encoded version of the first packet includes cyclic redundancy check (CRC) bits that are masked using the UE specific identifier. In some implementations, an un-encoded version of the second packet includes CRC bits that are masked using the UE group specific identifier.

In some implementations, at least one packet of the plurality of packets includes data that is encrypted by higher layers.

In some implementations, the first packet is associated with a first priority, and the second packet is associated with a second priority different from the first priority.

In some implementations, when the first priority is higher than the second priority, forwarding the second packet is delayed by forwarding the first packet; and when the first priority is lower than the second priority, forwarding the first packet is delayed by forwarding the second packet.

In some implementations, the plurality of packets further includes a third packet associated with a third priority lower than the first priority and the second priority, and method further includes dropping the third packet.

In some implementations, a priority of at least one packet of the plurality of packets is based on a priority of an RNTI associated with the at least one packet.

In some implementations, a priority of at least one packet of the plurality of packets is based on whether a destination of the at least one packet is an out-of-coverage UE.

In some implementations, a priority of at least one packet of the plurality of packets is based on whether the at least one packet includes an ultra-reliable low-latency communication (URLLC) packet.

In some implementations, a priority of at least one packet of the plurality of packets is based on whether the at least one packet includes an enhanced mobile broadband (eMBB) packet.

In some implementations, a priority of at least one packet of the plurality of packets is based on whether the at least one packet includes a re-transmission packet.

In some implementations, a priority of at least one packet of the plurality of packets is based on a modulation coding scheme (MCS) associated with higher reliability transmission for the at least one packet.

According to another example, there is provided a method including: receiving, by a UE in a predefined UE group, a plurality of packets; and forwarding, by the UE on a sidelink channel, at least one packet of the plurality of packets based on a priority of the at least one packet being higher than a priority of at least one other packet of the plurality of packets.

In some implementations, the at least one other packet is dropped. In some implementations, the at least one packet and the at least one other packet are designated to be forwarded on a same time-frequency resource.

In some implementations, forwarding the at least one packet includes forwarding a first packet and a second packet of the plurality of packets, where a priority of the first packet is higher than a priority of the second packet, and where forwarding the second packet is delayed by forwarding the first packet.

In some implementations, the first packet and the second packet are designated to be forwarded on a same time-frequency resource.

In some implementations, forwarding the at least one packet is further based on a transmit power that is available to the UE.

In some implementations, the method further includes determining, by the UE, a respective destination of each packet of the plurality of packets.

In some implementations, forwarding the at least one packet includes forwarding the at least one packet on the sidelink channel to another UE in the UE group.

According to a further example, there is provided a method including: transmitting, on a physical downlink shared channel (PDSCH), a first packet that is scrambled using a UE specific identifier, the UE specific identifier being associated with a UE in a predefined UE group; and transmitting, on the PDSCH, a second packet that is scrambled using a UE group specific identifier, the UE group specific identifier being associated with the UE group.

In some implementations, the first packet and/or the second packet is received by a second UE in the UE group. In some implementations, the first packet is forwarded to the UE by the second UE. In some implementations, the second packet is forwarded to the UE by the second UE.

In some implementations, the first packet includes first cyclic redundancy check (CRC) bits that are masked using the UE specific identifier, and the second packet includes second CRC bits that are masked using the UE group specific identifier.

In some implementations, the first packet or the second packet includes data that is encrypted.

In some implementations, the first packet or the second packet is associated with downlink control information (DCI), and the DCI includes at least one of a packet destination identifier and a packet source identifier.

According to yet another example, there is provided a UE configured to perform the method of any one of the methods described herein.

According to a further example, there is provided a base station configured to perform the method of any one of the methods described herein.

According to another example, there is provided an apparatus including: at least one antenna; a processor; and a non-transitory computer readable storage medium storing processor executable instructions for execution by the processor, the processor executable instructions including instructions causing the apparatus to perform a method according to any one of the methods described herein.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
receiving, by a first user equipment (UE), a first index assigned to a second UE;
receiving, by the first UE, a plurality of packets, the plurality of packets including a first packet and a second packet;
determining, for the first packet:
a first packet destination identifier, the first packet destination identifier being the same as the first index assigned to the second UE; and
a first packet priority;
determining, for the second packet:
a second packet destination identifier, the second packet destination identifier being the same as the first index assigned to the second UE; and
a second packet priority;
determining that the first packet priority is higher than the second packet priority; and
forwarding, by the first UE, the first packet to the second UE.

2. The method of claim 1, wherein the first packet includes the first packet destination identifier and the first packet destination identifier comprises a relative identifier.

3. The method of claim 1, wherein the determining the first packet destination identifier comprises deriving the first packet destination identifier from a bit field in the first packet.

4. The method of claim 1, wherein the forwarding the first packet comprises:
decoding the first packet to obtain a decoded first packet;
re-encoding the decoded first packet obtain a re-encoded first packet; and
transmitting the re-encoded first packet.

5. The method of claim 1, further comprising determining, for the first packet, a first packet source identifier.

6. The method of claim 1, further comprising forwarding, by the first UE, the second packet to the second UE, wherein the forwarding the second packet is carried out after the forwarding the first packet.

7. The method of claim 1, wherein the determining the first packet priority comprises determining a priority of a radio network temporary identifier (RNTI) associated with the first packet.

8. The method of claim 1, wherein the determining the first packet priority comprises determining that the first packet includes an ultra-reliable low-latency communication (URLLC) packet.

9. The method of claim 1, wherein the determining the first packet priority comprises determining that the first packet includes a re-transmission packet.

10. The method of claim 1, wherein the determining the first packet priority comprises determining a modulation coding scheme (MCS) associated with higher reliability transmission for the first packet.

11. An apparatus in a UE group, the apparatus comprising:
a memory for storing instructions; and
a processor coupled to the memory for executing the instructions, the processor configured to:
receive a first index assigned to a second user equipment (UE);
receive a plurality of packets including a first packet and a second packet;
determine, for the first packet:
a first packet destination identifier, the first packet destination identifier being the same as the first index assigned to the second UE; and
a first packet priority;
determine, for the second packet:
a second packet destination identifier, the second packet destination identifier being the same as the first index assigned to the second UE; and
a second packet priority;
determine that the first packet priority is higher than the second packet priority; and
forward the first packet to the second UE.

12. The apparatus of claim 11, wherein the first packet includes the first packet destination identifier and the first packet destination identifier comprises a relative identifier.

13. The apparatus of claim 11, wherein the processor is configured to determine the first packet destination identifier by deriving the first packet destination identifier from a bit field in the first packet.

14. The apparatus of claim 11, wherein the processor is configured to forward the first packet by:
decoding the first packet to obtain a decoded first packet;
re-encoding the first packet to obtain a re-encoded first packet; and
transmitting the re-encoded first packet.

15. The apparatus of claim 11, wherein the processor is further configured to determine, for the first packet, a first packet source identifier.

16. The apparatus of claim 11, wherein the processor is further configured to forward the second packet to the second UE, wherein the forwarding the second packet is carried out after the forwarding the first packet

17. The apparatus of claim 11, wherein the processor is configured to determine the first packet priority by determining a priority of a radio network temporary identifier (RNTI) associated with the first packet.

18. The apparatus of claim 11, the processor is configured to determine the first packet priority by determining that the first packet includes an ultra-reliable low-latency communication (URLLC) packet.

19. The apparatus of claim 11, wherein the processor is configured to determine the first packet priority by determining that the first packet includes a re-transmission packet.

20. The apparatus of claim 11, wherein the processor is configured to determine the first packet priority by determining a modulation coding scheme (MCS) associated with higher reliability transmission for the first packet.
